(19) United States
(12) Patent Application Publication
(10) Pub. No.: US 2025/0035497 A1
(43) Pub. Date: Jan. 30, 2025

(54) SENSOR SHEET

(71) Applicant: Sumitomo Riko Company Limited, Aichi (JP)

(72) Inventors: Masaki Nasu, Aichi (JP); Michelle Janetzko, Aichi (JP); Tetsuya Yoshida, Aichi (JP); Tomonori Hayakawa, Aichi (JP); Katsuhiko Nakano, Aichi (JP)

(73) Assignee: Sumitomo Riko Company Limited, Aichi (JP)

(21) Appl. No.: 18/912,571

(22) Filed: Oct. 10, 2024

Related U.S. Application Data
(63) Continuation of application No. PCT/JP2024/000967, filed on Jan. 16, 2024.

(30) Foreign Application Priority Data
Jan. 27, 2023 (JP) 2023-011221

(51) Int. Cl. G01L 5/22; B62D 1/04; G01L 1/20; G01L 1/22

(52) U.S. Cl. CPC G01L 5/221; B62D 1/046; G01L 1/205; G01L 1/22

(57) ABSTRACT

A sensor sheet (20) includes an insulator sheet (21) made of an elastomer; a detection electrode (22) made of an elastomer that includes a conductive material and disposed on an upper surface of the insulator sheet (21); a first bypass conductor (23) disposed on an upper surface of the detection electrode (22) and extending in a longitudinal direction corresponding to a direction of a central axis (14) of a core material (15); a first lead wire (28) associated with the detection electrode (22); and a first wiring conductor (24) disposed between the first bypass conductor (23) and the first lead wire (28), spaced apart from the first bypass conductor (23), and electrically connected to the detection electrode (22). One end (24A) of the first wiring conductor (24) is electrically connected in a state of contact with the first lead wire (28), and the other end (24B) of the first wiring conductor (24) is spaced apart from the first bypass conductor (23) with a first end portion gap (41) therebetween.

### CROSS-REFERENCE TO RELATED APPLICATION

The present application is a continuation of PCT/JP2024/000967, filed on Jan. 16, 2024, and is related to and claims priority from Japanese Patent Application No. 2023-011221 filed on Jan. 27, 2023. The entire contents of the aforementioned application are hereby incorporated by reference herein.

### TECHNICAL FIELD

The disclosure relates to a sensor sheet.

### RELATED ART

Patent Document 1 (International Publication No. 2020/217855) describes a sensor sheet that is attached to a steering wheel. In a case where the object to which the sheet-like sensor sheet is to be attached has a three-dimensional shape (including three-dimensional curved surfaces and complex planes), such as a steering wheel, the sensor sheet is required to be flexible from the viewpoint of attachability. In other words, the sensor sheet needs to be deformed while being attached to the object.

The technology described in Patent Document 1 discloses a technique that imparts flexibility to the sensor sheet by applying an electrode sheet made of an elastomer which includes a conductive filler to the sensor sheet.

However, the elastomer including the conductive filler becomes harder when the mixing ratio of the conductive filler is increased, and becomes softer when the mixing ratio of the conductive filler is decreased, but the electrical resistivity increases.

Thus, Patent Document 1 describes a sensor sheet that, in an electrode sheet made of an elastomer including a conductive filler, the conductive filler is mixed in a ratio that enables the desired flexibility to be exhibited, and the sensor sheet includes at least one bypass conductor electrically connected to the electrode sheet.

However, in the technology described in Patent Document 1, a terminal portion for connecting the sensor sheet to an external circuit is disposed on the electrode sheet made of the elastomer including the conductive filler. Therefore, an electrical signal (current, voltage, or the like) detected in the electrode sheet is transmitted in the order of the electrode sheet, the bypass conductor, the electrode sheet, and the terminal portion. As a result, the electrical resistance of the electrode sheet located between the bypass conductor and the terminal portion may become large depending on the arrangement of the terminal portion on the sensor sheet, which may result in a decrease in the detection accuracy of the sensor sheet.

The disclosure provides a sensor sheet that is flexible and capable of improving detection accuracy.

### SUMMARY

One aspect of the disclosure provides
a sensor sheet to be wound around a winding target member of a steering wheel that has a core material, the sensor sheet including:
an insulator sheet made of an elastomer;
at least one detection electrode made of an elastomer that includes a conductive material, disposed on an upper surface of the insulator sheet, and constituting at least one detection region;
a first bypass conductor disposed on an upper surface of the detection electrode and extending in a longitudinal direction corresponding to a direction of a central axis of the core material;
a first lead wire associated with the detection electrode; and
a first wiring conductor disposed between the first bypass conductor and the first lead wire, spaced apart from the first bypass conductor, and electrically connected to the detection electrode,
in which one end of the first wiring conductor is electrically connected to the first lead wire, and is disposed in a state of contact with the first lead wire or is disposed at a position closer to the first lead wire than the first bypass conductor, and
an other end of the first wiring conductor is disposed at a position closer to the first bypass conductor than one end of the first wiring conductor, and is spaced apart from the first bypass conductor with a first end portion gap therebetween.

Another aspect of the disclosure provides
a sensor sheet to be wound around a winding target member of a steering wheel that has a core material, the sensor sheet including:
an insulator sheet made of an elastomer;
at least one detection electrode made of an elastomer that includes a conductive material, disposed on an upper surface of the insulator sheet, and constituting at least one detection region; and
a first bypass conductor disposed on an upper surface of each of the at least one detection electrode and extending in a longitudinal direction corresponding to a direction of a central axis of the core material,
in which the first bypass conductor includes a plurality of first divided bypass conductors arranged in the longitudinal direction with first bypass intermediate gaps therebetween.

According to one aspect of the disclosure, the sensor sheet is easily deformed in the first end portion gap. As a result, the sensor sheet as a whole is easily deformed, which improves the attachability when the sensor sheet is attached to the steering wheel. Moreover, the electrical resistance between the first lead wire and the first bypass conductor can be reduced compared to a case without the first wiring conductor. Thus, the detection accuracy of the sensor sheet can be improved.

According to another aspect of the disclosure, the first bypass conductor is provided, thereby making it possible to reduce the electrical resistance of the detection electrode. Thus, the detection accuracy of the sensor sheet can be further improved. In addition, the first bypass conductor includes a plurality of first divided bypass conductors arranged with the first bypass intermediate gaps therebetween. Thus, the sensor sheet is easily deformed in the first bypass intermediate gaps. As a result, the sensor sheet as a whole is easily deformed, which improves the attachability when the sensor sheet is attached to the steering wheel.

It should be noted that the reference numerals in parentheses in the claims indicate the corresponding relationship with the specific means described in the following embodiments, and are not intended to limit the technical scope of the disclosure.

### BRIEF DESCRIPTION OF DRAWINGS

FIG. 1 is a front view showing the steering wheel to which the sensor sheet of the first embodiment is attached.

FIG. 2 is a cross-sectional view taken along line II-II of FIG. 1.

FIG. 3 is a plan view showing the sensor sheet of the first embodiment.

FIG. 4 is a bottom view showing the sensor sheet of the first embodiment.

FIG. 5 is a cross-sectional view taken along line V-V of FIG. 3.

FIG. 6 is a cross-sectional view taken along line VI-VI of FIG. 3.

FIG. 7 is a cross-sectional view taken along line VII-VII of FIG. 3.

FIG. 8 is a plan view showing the sensor sheet of the second embodiment.

FIG. 9 is a plan view showing the sensor sheet of the third embodiment.

FIG. 10 is a plan view showing the sensor sheet of the fourth embodiment.

FIG. 11 is a plan view showing the sensor sheet of the fifth embodiment.

FIG. 12 is a plan view showing the sensor sheet of the sixth embodiment.

FIG. 13 is a plan view showing the sensor sheet of the seventh embodiment.

FIG. 14 is a plan view showing the sensor sheet of the eighth embodiment.

FIG. 15 is a plan view showing the sensor sheet of the ninth embodiment.

FIG. 16 is a cross-sectional view showing the sensor sheet of the tenth embodiment, corresponding to line VII-VII of FIG. 3.

FIG. 17 is a plan view showing the sensor sheet of the eleventh embodiment.

FIG. 18 is a plan view showing the sensor sheet of the twelfth embodiment.

FIG. 19 is a cross-sectional view showing the sensor sheet of the thirteenth embodiment, corresponding to line V-V of FIG. 3.

FIG. 20 is a cross-sectional view showing the sensor sheet of the thirteenth embodiment, corresponding to line VI-VI of FIG. 3.

FIG. 21 is a cross-sectional view showing the sensor sheet of the fourteenth embodiment, corresponding to line V-V of FIG. 3.

FIG. 22 is a cross-sectional view showing the sensor sheet of the fourteenth embodiment, corresponding to line VI-VI of FIG. 3.

FIG. 23 is a plan view showing the sensor sheet of the fifteenth embodiment.

FIG. 24 is a bottom view showing the sensor sheet of the sixteenth embodiment.

### DESCRIPTION OF EMBODIMENTS

### First Embodiment

### 1. Configuration of Steering Wheel 10

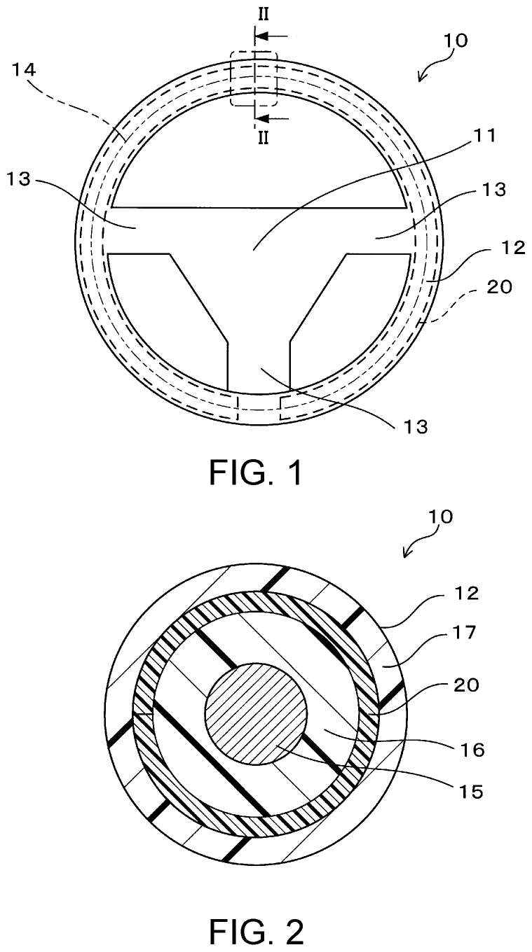

The first embodiment will be described with reference to FIG. 1 to FIG. 2. This embodiment relates to a sensor sheet 20 attached to a steering wheel 10.

As shown in FIG. 1, the steering wheel 10 includes a core portion 11, a ring portion 12, and a plurality of (three in this embodiment) connecting portions 13 that connect the core portion 11 and the ring portion 12.

The ring portion 12 is a shaft member having a central axis 14 that forms a convex curve (a circular shape in this embodiment). The ring portion 12 of this embodiment is formed in a circular ring shape. However, the ring portion 12 is not limited to a circular shape, and can be formed in any shape such as an elliptical shape.

As shown in FIG. 2, the ring portion 12 includes a core material 15, a resin inner layer material 16, a sensor sheet 20, and a skin material 17. The core material 15 constitutes the central portion of the ring portion 12 and is formed in a shape corresponding to the shape of the ring portion 12. In this embodiment, the core material 15 is formed in a circular ring shape. The core material 15 can have any shape, such as an elliptical shape, to correspond to the ring portion 12. The core material 15 is made of, for example, conductive metal such as aluminum. The core material 15 may be connected to, for example, a ground potential. Although the cross section of the core material 15 perpendicular to the axis is formed in a circular shape in the example shown, the cross section can have any shape such as a U shape, an elliptical shape, and a polygonal shape. The core material 15 may be made of non-conductive resin.

The resin inner layer material 16 covers the outer surface of the core material 15 over the entire circumference of the ring shape of the core material 15 and over the entire circumference of the circular cross-sectional shape of the core material 15. In this embodiment, the cross section of the resin inner layer material 16 perpendicular to the axis is formed in a circular shape. The cross-sectional shape of the resin inner layer material 16 perpendicular to the axis is not limited to a circular shape, and can be any shape such as an egg shape, an elliptical shape, and a polygonal shape. The resin inner layer material 16 is molded by injection molding, and is directly bonded to the surface of the core material 15. The resin inner layer material 16 is, for example, molded from foamed resin such as urethane foam. The resin inner layer material 16 can also use non-foamed resin.

The sensor sheet 20 is wound around the outer surface of the resin inner layer material 16. The sensor sheet 20 will be described in detail later. In this embodiment, the core material 15 and the resin inner layer material 16 disposed on the outer surface of the core material 15 correspond to the winding target member. However, in a case where a heater is wound around the outer surface of the resin inner layer material 16, the core material 15, the resin inner layer material 16, and the heater become the winding target member. Thus, the winding target member is not particularly limited.

The skin material 17 covers the surface of the sensor sheet 20. The skin material 17 may be molded by injection molding using resin, or leather can also be used as the skin material 17. The skin material 17 covers the outer surface of the sensor sheet 20 over the entire circumference of the ring shape of the sensor sheet 20 and over the entire circumference of the cross-sectional shape of the sensor sheet 20 perpendicular to the axis.

### 2. Configuration of Sensor Sheet 20

### 2-1. Overall Configuration of Sensor Sheet 20

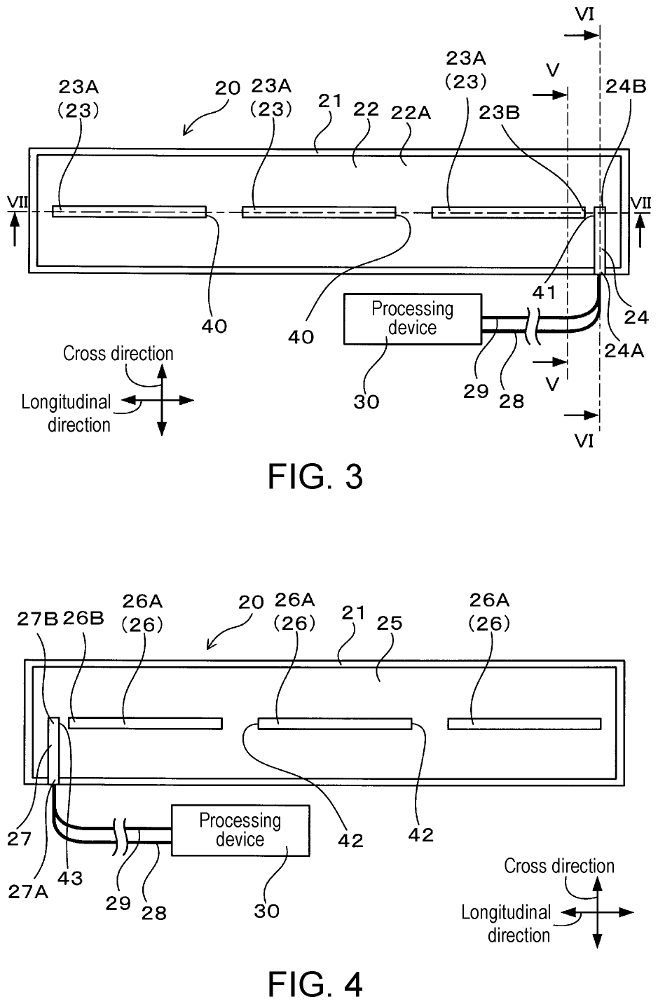

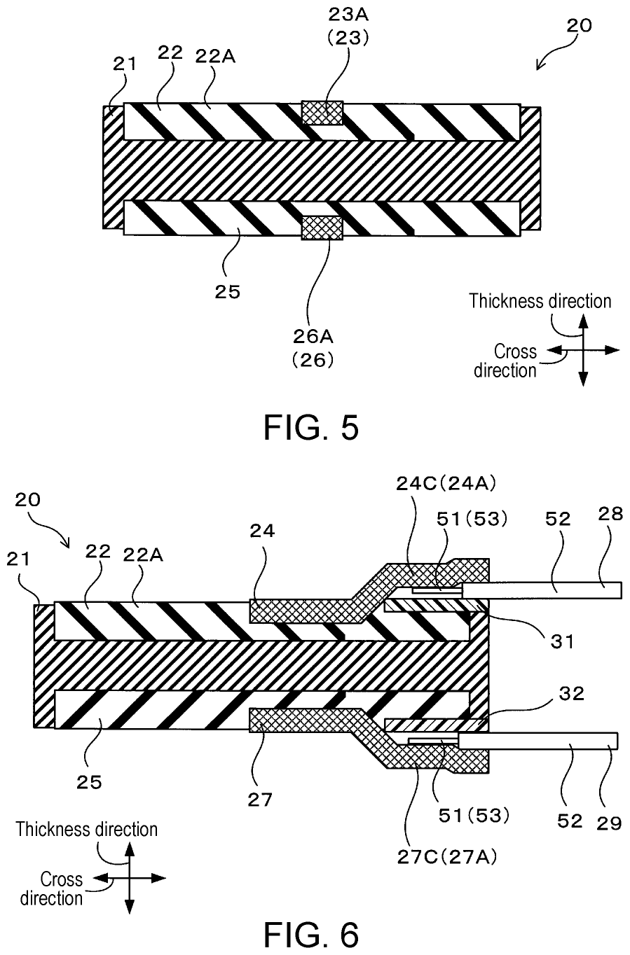

The sensor sheet 20 of this embodiment will be described with reference to FIG. 3 to FIG. 7. In FIG. 5 to FIG. 7, the thickness is exaggerated for ease of illustration. Although not specifically mentioned, the thickness may be exaggerated in other drawings as well.

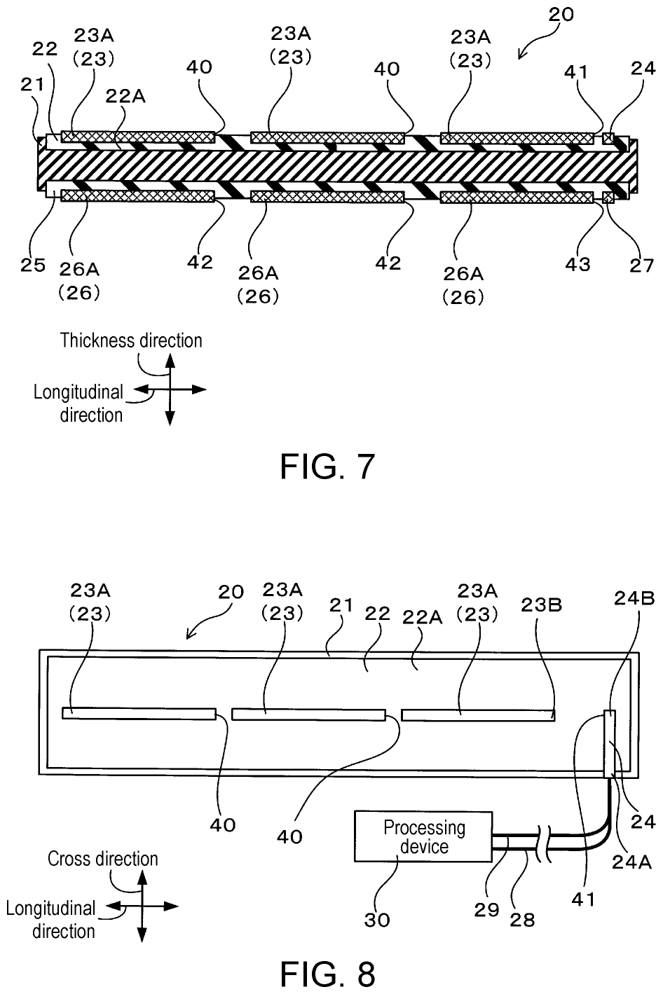

As shown in FIG. 7, the sensor sheet 20 includes an insulator sheet 21, a detection electrode 22, a first bypass conductor 23, a first wiring conductor 24, a shield electrode 25, a second bypass conductor 26, and a second wiring conductor 27. As shown in FIG. 3 and FIG. 4, the sensor sheet 20 is connected to a processing device 30 via a first lead wire 28 and a second lead wire 29. The first lead wire 28 is associated with the detection electrode 22, and the second lead wire 29 is associated with the shield electrode 25.

As shown in FIG. 3, the sensor sheet 20 is formed in a planar shape that is long in the longitudinal direction. The longitudinal direction corresponds to the direction of the central axis 14 of the core material 15. The sensor sheet 20 is flexible and is configured to be stretchable so that the sensor sheet 20 can be in any shape. In other words, the sensor sheet 20 shown in FIG. 3 shows an initial state before deformation.

### 2-2. Insulator Sheet 21

FIG. 5 shows the insulator sheet 21. The insulator sheet 21 is made of an elastomer. Therefore, the insulator sheet 21 is elastically deformable. The insulator sheet 21 is made of, for example, a thermoplastic elastomer. The insulator sheet 21 may be made of a thermoplastic elastomer itself, or may be made of an elastomer that is crosslinked by heating a thermoplastic elastomer as a raw material.

Here, the insulator sheet 21 can be made of one or more elastomers selected from styrene-based, olefin-based, vinyl chloride-based, urethane-based, ester-based, and amide-based elastomers. For example, the styrene-based elastomers include SBS, SEBS, SEPS, and the like. Examples of the olefin-based elastomers include EEA, EMA, EMMA, and also copolymers of ethylene and a-olefins (ethylene-octene copolymers).

The insulator sheet 21 may include rubber or resin other than the thermoplastic elastomer. For example, in a case where the insulator sheet 21 includes rubber such as ethylene-propylene rubber (EPM, EPDM), the flexibility of the insulator sheet 21 is improved. From the viewpoint of improving the flexibility of the insulator sheet 21, the insulator sheet 21 may contain a flexibility-imparting component such as a plasticizer.

### 2-3. Detection Electrode 22

As shown in FIG. 5, the detection electrode 22 is disposed on the upper surface (the upper surface of FIG. 5) side of the insulator sheet 21. The detection electrode 22 forms a detection region 22A in the sensor sheet 20. More specifically, a region where the detection electrode 22 and the shield electrode 25 are disposed to overlap, with respect to the thickness direction of the insulator sheet 21, is defined as the detection region 22A.

As shown in FIG. 3, the detection electrode 22 is formed in a sheet shape that is long in the longitudinal direction. The length dimension of the detection electrode 22 in the longitudinal direction is slightly smaller than the length dimension of the insulator sheet 21 in the longitudinal direction. The length dimension of the detection electrode 22 in the cross direction is slightly smaller than the length dimension of the insulator sheet 21 in the cross direction. The cross direction refers to a direction intersecting with the longitudinal direction and a direction extending along the upper surface of the insulator sheet 21. The detection electrode 22 of this embodiment is embedded in the upper surface of the insulator sheet 21 with the upper surface of the detection electrode 22 exposed. However, the detection electrode 22 may be laminated on the upper surface of the insulator sheet 21.

The detection electrode 22 is conductive, flexible, and stretchable in the planar direction. The detection electrode 22 is made of a conductive elastomer. That is, the detection electrode 22 is made of an elastomer including a conductive filler.

The elastomer used in the detection electrode 22 is preferably made of a material having the same type of main component as the insulator sheet 21. That is, the detection electrode 22 can be made of one or more elastomers selected from styrene-based, olefin-based, vinyl chloride-based, urethane-based, ester-based, and amide-based elastomers. For example, the styrene-based elastomers include SBS, SEBS, SEPS, and the like. Examples of the olefin-based elastomers include EEA, EMA, EMMA, and also copolymers of ethylene and a-olefins (ethylene-octene copolymers).

However, the detection electrode 22 is selected to have a higher softening point than the insulator sheet 21. This is to enable the insulator sheet 21 to soften before the detection electrode 22 when the detection electrode 22 is fixed to the insulator sheet 21 by fusing (for example, heat fusing) the insulator sheet 21 itself.

The detection electrode 22 is fixed to the insulator sheet 21 by fusing (for example, heat fusing) the insulator sheet 21 itself. Furthermore, the detection electrode 22 and the insulator sheet 21 are fixed to each other by fusing (for example, heat fusing) the detection electrode 22 itself. In other words, the detection electrode 22 and the insulator sheet 21 are fixed to each other by fusing to each other.

As shown in FIG. 3, in this embodiment, one detection electrode 22 is disposed on one insulator sheet 21. However, a configuration in which a plurality of detection electrodes 22 are disposed on one insulator sheet 21 may also be used. A plurality of detection electrodes 22 may be arranged on the upper surface of the insulator sheet 21 along the longitudinal direction, or along the cross direction.

### 2-4. First Bypass Conductor 23

As shown in FIG. 5, the first bypass conductor 23 is disposed on the upper surface of the detection electrode 22. The first bypass conductor 23 includes a plurality of first divided bypass conductors 23A. Each of the first divided bypass conductors 23A constituting the first bypass conductor 23 is embedded in the upper surface of the detection electrode 22 with the upper surface of each of the first divided bypass conductors 23A exposed. However, each of the first divided bypass conductors 23A may be laminated on the upper surface of the detection electrode 22.

As shown in FIG. 3, the first bypass conductor 23 extends in the longitudinal direction. The first bypass conductor 23 of this embodiment includes a plurality of (three in this embodiment) first divided bypass conductors 23A. The plurality of first divided bypass conductors 23A are arranged side by side in the longitudinal direction with first bypass intermediate gaps 40 therebetween. However, the first bypass conductor 23 may not have the first divided bypass conductors 23A, or may include two or four or more first divided bypass conductors 23A.

The length dimension of each of the first divided bypass conductors 23A in the cross direction is smaller than the length dimension of the detection electrode 22 in the cross direction. In this embodiment, each of the first divided bypass conductors 23A is disposed near the center position of the detection electrode 22 in the cross direction.

The first bypass conductor 23 is disposed to extend from one end portion (the right end in FIG. 3) of the detection electrode 22 in the longitudinal direction to the other end portion (the left end in FIG. 3). In other words, the plurality of first divided bypass conductors 23A are arranged side by side with the first bypass intermediate gaps 40 therebetween from one end portion to the other end portion of the detection electrode 22. In this embodiment, the gap dimension of each of the first bypass intermediate gaps 40 is set to be the same with respect to the longitudinal direction. However, the gap dimension of each of the first bypass intermediate gaps 40 may be different.

Each of the first divided bypass conductors 23A constituting the first bypass conductor 23 has an electrical resistivity smaller than the electrical resistivity of the detection electrode 22. It is particularly effective to set the electrical resistivity of each of the first divided bypass conductors 23A to 1/10 or less of the electrical resistivity of the detection electrode 22. Each of the first divided bypass conductors 23A is electrically connected to the detection electrode 22 at a portion where the first divided bypass conductor 23A is in contact with the detection electrode 22.

The material for forming each of the first divided bypass conductors 23A constituting the first bypass conductor 23 is not particularly limited, and examples thereof include the following materials.

### (1) Metal Wire

The first divided bypass conductor 23A may be made of a metal wire. The metal wire is, for example, a copper wire, a nichrome wire, or the like. In this case, the electrical resistivity of the first divided bypass conductor 23A can be set to 1/10 or less, or even 1/100 or less, of the electrical resistivity of the detection electrode 22. The first divided bypass conductor 23A is fixed to the detection electrode 22 by fusing (for example, heat fusing) the detection electrode 22 itself.

### (2) Conductive Fiber

The first divided bypass conductor 23A may be made of a conductive fiber. The conductive fiber is formed by coating the surface of a flexible fiber with a conductive material. The conductive fiber is formed, for example, by plating the surface of a resin fiber such as polyethylene with copper, nickel, or the like. The first divided bypass conductor 23A may be made of a conductive cloth (woven or nonwoven fabric) made of conductive fibers. The electrical resistivity of the first divided bypass conductor 23A can be set to 1/10 or less, or even 1/100 or less, of the electrical resistivity of the detection electrode 22. The first divided bypass conductor 23A is fixed to the detection electrode 22 by fusing (for example, heat fusing) the detection electrode 22 itself.

As the first divided bypass conductor 23A is made of a conductive fiber, the detection electrode 22 softens and enters the space between the conductive fibers. Thus, the first divided bypass conductor 23A is more firmly fixed to the detection electrode 22.

In addition, preferably the first divided bypass conductor 23A is made of a conductive cloth having a mesh and formed in a sheet shape, and furthermore, the orientation direction of the mesh is inclined with respect to the longitudinal direction of the detection electrode 22. This allows the first divided bypass conductor 23A to elongate in the longitudinal direction of the detection electrode 22. In other words, the first divided bypass conductor 23A can follow the elongation deformation of the detection electrode 22 when the detection electrode 22 elongates in the longitudinal direction. As a result, the elongation performance of the sensor sheet 20 is improved. In particular, the orientation direction of the mesh of the first divided bypass conductor 23A may be inclined at 45° with respect to the longitudinal direction of the detection electrode 22. Thereby, the elongation performance of the sensor sheet 20 in the longitudinal direction and the lateral direction is improved.

### (3) Conductive Elastomer

The first divided bypass conductor 23A may be made of a conductive elastomer. In other words, the first divided bypass conductor 23A may be made of an elastomer including a conductive filler. However, each of the first divided bypass conductors 23A constituting the first bypass conductor 23 has a smaller electrical resistivity than the detection electrode 22. Therefore, in a case where the same type of conductive filler is applied, the ratio of the conductive filler applied to the first divided bypass conductor 23A is high. The elastomer applied to the first divided bypass conductor 23A is preferably the same type as the elastomer used for the detection electrode 22.

As the first divided bypass conductor 23A is made of an elastomer, the flexibility of the entire sensor sheet 20 is increased. Furthermore, as the same type of elastomer is used for the first divided bypass conductor 23A and the detection electrode 22, the adhesion therebetween is further improved.

### 2-5. First Wiring Conductor 24

As shown in FIG. 3, the first wiring conductor 24 is disposed at one end portion (the right end portion in FIG. 3) of the detection electrode 22 in the longitudinal direction. The first wiring conductor 24 is disposed on the upper surface of the detection electrode 22. The first wiring conductor 24 is embedded in the upper surface of the detection electrode 22 with the upper surface of the first wiring conductor 24 exposed. However, the first wiring conductor 24 may be laminated on the upper surface of the detection electrode 22.

The first wiring conductor 24 extends linearly in the cross direction. However, the first wiring conductor 24 may extend in a curved shape along the cross direction, or may extend while bending along the cross direction.

One end 24A of the first wiring conductor 24 is disposed on one of the side edges of the detection electrode 22 that intersects with the cross direction. The other end 24B of the first wiring conductor 24 is disposed near the center position of the detection electrode 22 with respect to the cross direction. The other end 24B of the first wiring conductor 24 is disposed at a position closer to the first bypass conductor 23 than one end 24A of the first wiring conductor 24.

The first wiring conductor 24 is spaced apart from the first bypass conductor 23. In this embodiment, the other end 24B of the first wiring conductor 24 is spaced apart in the longitudinal direction from one end 23B of the first divided bypass conductor 23A constituting the first bypass conductor 23 in the longitudinal direction. The gap between the first divided bypass conductor 23A and the first wiring conductor 24 is defined as a first end portion gap 41.

The first wiring conductor 24 has an electrical resistivity smaller than the electrical resistivity of the detection electrode 22. It is particularly effective to set the electrical resistivity of the first wiring conductor 24 to 1/10 or less of the electrical resistivity of the detection electrode 22. The first wiring conductor 24 is electrically connected to the detection electrode 22 at a portion where the first wiring conductor 24 is in contact with the detection electrode 22.

Since the first wiring conductor 24 can be made of the same material as the material constituting the first bypass conductor 23, repeated description will be omitted.

As shown in FIG. 6, one end 24A of the first wiring conductor 24 is defined as a non-contact region 24C that is not in contact with the upper surfaces of the insulator sheet 21 and the detection electrode 22. A first bond restriction layer 31 is disposed on the upper surfaces of the insulator sheet 21 and the detection electrode 22 at a position corresponding to the non-contact region 24C of the first wiring conductor 24. The first bond restriction layer 31 is made of insulating synthetic resin and is formed in a sheet shape. The first bond restriction layer 31 is configured to prevent the non-contact region 24C of the first wiring conductor 24 from coming into direct contact with the upper surfaces of the insulator sheet 21 and the detection electrode 22.

The first bond restriction layer 31 is bonded to the insulator sheet 21 by fusing (for example, heat fusing) the insulator sheet 21 itself. The first bond restriction layer 31 is, for example, made of a material having a softening point higher than the softening point of the insulator sheet 21. For example, the first bond restriction layer 31 can be a resin sheet made of a thermoplastic material.

An end portion of the first lead wire 28 is disposed between the first bond restriction layer 31 and the non-contact region 24C of the first wiring conductor 24.

One end 24A of the first wiring conductor 24 is connected to the first lead wire 28. The first lead wire 28 includes a core wire 51 and a covering portion 52 that covers the outer peripheral surface of the core wire 51 in an insulating manner. The core wire 51 is made of conductive metal such as copper, a copper alloy, aluminum, and an aluminum alloy. The covering portion 52 is made of a thermoplastic material. The covering portion 52 may be made of any thermoplastic material having insulating properties, and may be made of, for example, a material applicable to the above-mentioned insulator sheet 21.

The first lead wire 28 includes, at the tip portion of the first lead wire 28, an exposed core wire portion 53 where the covering portion 52 is stripped away to expose the core wire 51.

The exposed core wire portion 53 can be configured, for example, as follows. The exposed core wire portion 53 is formed by forming a metal plating layer on the core wire 51 made of a metal wire. In this case, nickel plating is suitable for the metal plating layer. Moreover, the exposed core wire portion 53 may be formed by forming a solder flow layer on the core wire 51. The metal plating layer and the solder flow layer serve to improve conduction with the first wiring conductor 24.

The exposed core wire portion 53 of the first lead wire 28 is disposed on the far side of the non-contact region 24C of the first wiring conductor 24 with respect to the cross direction. The first lead wire 28 extends from an edge of the first wiring conductor 24 in a direction away from the sensor sheet 20 with respect to the cross direction.

The non-contact region 24C of the first wiring conductor 24 and the core wire 51 in the exposed core wire portion 53 are electrically connected via, for example, a metal plating layer or a solder flow layer. Specifically, after the first lead wire 28 is inserted between the first wiring conductor 24 and the first bond restriction layer 31, an ultrasonic welding process is performed on the non-contact region 24C of the first wiring conductor 24, thereby electrically connecting the first wiring conductor 24 and the exposed core wire portion 53 of the first lead wire 28. Since the first wiring conductor 24 and the exposed core wire portion 53 of the first lead wire 28 have metal on the surfaces, the first wiring conductor 24 and the exposed core wire portion 53 of the first lead wire 28 are bonded by ultrasonic welding. On the other hand, although the exposed core wire portion 53 of the first lead wire 28 and the first bond restriction layer 31 are adjacent to each other, the exposed core wire portion 53 of the first lead wire 28 and the first bond restriction layer 31 are made of metal and resin, so the exposed core wire portion 53 of the first lead wire 28 and the first bond restriction layer 31 are not welded to each other even if ultrasonic welding is performed.

### 2-6. Shield Electrode 25

As shown in FIG. 5, the shield electrode 25 is laminated on the lower surface (the lower surface in FIG. 5) side of the insulator sheet 21, that is, on the surface of the insulator sheet 21 opposite to the detection electrode 22. In other words, the shield electrode 25 is disposed between the insulator sheet 21 and the resin inner layer material 16 of the steering wheel 10. As shown in FIG. 4, the shield electrode 25 is formed in a sheet shape that is long in the longitudinal direction. The length dimension of the shield electrode 25 in the longitudinal direction is slightly smaller than the length dimension of the insulator sheet 21 in the longitudinal direction. The length dimension of the shield electrode 25 in the cross direction is slightly smaller than the length dimension of the insulator sheet 21 in the cross direction. As shown in FIG. 5, the shield electrode 25 of this embodiment is embedded in the lower surface of the insulator sheet 21 with the lower surface of the shield electrode 25 exposed. However, the shield electrode 25 may be laminated on the lower surface of the insulator sheet 21.

The shield electrode 25 is disposed at a position overlapping the detection electrode 22 in the thickness direction of the insulator sheet 21. The shield electrode 25 of this embodiment has the same shape and size as the detection electrode 22. However, the shield electrode 25 may be larger than the detection electrode 22.

The shield electrode 25 of this embodiment is conductive, flexible, and stretchable in the planar direction. The shield electrode 25 is made of a conductive elastomer. That is, the shield electrode 25 is made of an elastomer including a conductive filler. Since the conductive elastomer used in the shield electrode 25 is the same as the conductive elastomer used in the detection electrode 22, repeated description will be omitted. However, the shield electrode 25 may be made of a conductive cloth made of conductive fibers.

### 2-7. Second Bypass Conductor 26

As shown in FIG. 4, the second bypass conductor 26 is disposed on the lower surface of the shield electrode 25. The second bypass conductor 26 includes a plurality of second divided bypass conductors 26A. Each of the second divided bypass conductors 26A constituting the second bypass conductor 26 is embedded in the lower surface of the shield electrode 25 with the lower surface of each of the second divided bypass conductors 26A exposed. However, each of the second divided bypass conductors 26A may be laminated on the lower surface of the shield electrode 25.

As shown in FIG. 4, the second bypass conductor 26 extends in the longitudinal direction. The second bypass conductor 26 of this embodiment includes a plurality of (three in this embodiment) second divided bypass conductors 26A arranged side by side in the longitudinal direction with second bypass intermediate gaps 42 therebetween. However, the second bypass conductor 26 may not have the second divided bypass conductors 26A, or may include two or four or more second divided bypass conductors 26A.

The length dimension of each of the second divided bypass conductors 26A in the cross direction is smaller than the length dimension of the shield electrode 25 in the cross direction. In this embodiment, each of the second divided bypass conductors 26A is disposed near the center position of the shield electrode 25 in the cross direction.

The second bypass conductor 26 is disposed to extend from one end portion (the right end in FIG. 4) of the shield electrode 25 in the longitudinal direction to the other end portion (the left end in FIG. 4). In other words, the plurality of second divided bypass conductors 26A are arranged side by side with the second bypass intermediate gaps 42 therebetween from one end portion to the other end portion of the shield electrode 25. In this embodiment, the gap dimension of each of the second bypass intermediate gaps 42 is set to be the same with respect to the longitudinal direction. However, the gap dimension of each of the second bypass intermediate gaps 42 may be different.

Each of the second divided bypass conductors 26A constituting the second bypass conductor 26 has an electrical resistivity smaller than the electrical resistivity of the shield electrode 25. It is particularly effective to set the electrical resistivity of each of the second divided bypass conductors 26A to 1/10 or less of the electrical resistivity of the shield electrode 25. Each of the second divided bypass conductors 26A is electrically connected to the shield electrode 25 at a portion where the second divided bypass conductor 26A is in contact with the shield electrode 25.

Since the second bypass conductor 26 is made of the same material as the first bypass conductor 23, repeated description will be omitted.

### 2-8. Second Wiring Conductor 27

As shown in FIG. 4, the second wiring conductor 27 is disposed at one end portion (the left end portion in FIG. 4) of the shield electrode 25 in the longitudinal direction. The second wiring conductor 27 is disposed on the lower surface of the shield electrode 25. The second wiring conductor 27 is embedded in the lower surface of the shield electrode 25 with the lower surface of the second wiring conductor 27 exposed. However, the second wiring conductor 27 may be laminated on the lower surface of the shield electrode 25.

The second wiring conductor 27 extends linearly in the cross direction. However, the second wiring conductor 27 may extend in a curved shape along the cross direction, or may extend while bending along the cross direction.

One end 27A of the second wiring conductor 27 is disposed on one of the side edges of the shield electrode 25 that intersects with the cross direction. The other end 27B of the second wiring conductor 27 is disposed near the center position of the shield electrode 25 with respect to the cross direction.

The second wiring conductor 27 is spaced apart from the second bypass conductor 26. In this embodiment, the other end 27B of the second wiring conductor 27 is spaced apart in the longitudinal direction from one end 26B of the second divided bypass conductor 26A constituting the second bypass conductor 26 in the longitudinal direction. The gap between the second divided bypass conductor 26A and the second wiring conductor 27 is defined as a second end portion gap 43.

The second wiring conductor 27 has an electrical resistivity smaller than the electrical resistivity of the shield electrode 25. It is particularly effective to set the electrical resistivity of the second wiring conductor 27 to 1/10 or less of the electrical resistivity of the shield electrode 25. The second wiring conductor 27 is electrically connected to the shield electrode 25 at a portion where the second wiring conductor 27 is in contact with the shield electrode 25.

Since the second wiring conductor 27 can be made of the same material as the material constituting the first bypass conductor 23, repeated description will be omitted.

As shown in FIG. 6, one end 27A of the second wiring conductor 27 is defined as a non-contact region 27C that is not in contact with the lower surfaces of the insulator sheet 21 and the shield electrode 25. A second bond restriction layer 32 is disposed on the lower surfaces of the insulator sheet 21 and the shield electrode 25 at a position corresponding to the non-contact region 27C of the second wiring conductor 27. The second bond restriction layer 32 is made of insulating synthetic resin and is formed in a sheet shape. The second bond restriction layer 32 prevents the non-contact region 27C of the second wiring conductor 27 from coming into direct contact with the lower surfaces of the insulator sheet 21 and the shield electrode 25.

The second bond restriction layer 32 is bonded to the insulator sheet 21 by fusing (for example, heat fusing) the insulator sheet 21 itself. The second bond restriction layer 32 is, for example, made of a material having a softening point higher than the softening point of the insulator sheet 21. For example, the second bond restriction layer 32 can be a resin sheet made of a thermoplastic material.

An end portion of the second lead wire 29 is disposed between the second bond restriction layer 32 and the non-contact region 27C of the second wiring conductor 27.

The other end portion of the second wiring conductor 27 is connected to the second lead wire 29. Since the second lead wire 29 has the same configuration as the first lead wire 28, the same members are given the same reference numerals, and repeated description will be omitted.

### 2-9. Configurations of Bypass Conductors 23 and 26, Wiring Conductors 24 and 27, and Gaps 40, 41, 42, and 43

As shown in FIG. 3, in this embodiment, the spacing of the first bypass intermediate gap 40 is larger than the spacing of the first end portion gap 41 with respect to the longitudinal direction.

As shown in FIG. 7, the first bypass conductor 23 and the second bypass conductor 26 are disposed at positions overlapping each other in the thickness direction of the insulator sheet 21. Specifically, each of the first divided bypass conductors 23A and each of the second divided bypass conductors 26A are disposed at positions overlapping each other in the thickness direction of the insulator sheet 21. Further, each of the first bypass intermediate gaps 40 and each of the second bypass intermediate gaps 42 are disposed at positions overlapping each other in the thickness direction of the insulator sheet 21.

As shown in FIG. 7, the first wiring conductor 24 and the second wiring conductor 27 are disposed at positions overlapping each other in the thickness direction of the insulator sheet 21. Further, the first end portion gap 41 and the second end portion gap 43 are disposed at positions overlapping each other in the thickness direction of the insulator sheet 21.

The first bypass intermediate gap 40 and the first end portion gap 41 are smaller than the minimum width dimension of a detection object (not shown). Thus, the detection object comes into contact with at least the first bypass conductor 23 or the first wiring conductor 24, making it possible to detect whether or not the detection object has come into contact with the steering wheel 10. In this embodiment, contact or non-contact of a hand (palm of the hand, back of the hand, or finger), which is an example of the detection object, with respect to the steering wheel 10 is detected. Among parts of the hand which is the detection object, the smallest object to be detected is the finger, in which the tip of the finger is the smallest detection object. The first bypass intermediate gap 40, the second bypass intermediate gap 42, the first end portion gap 41, and the second end portion gap 43 are set to be smaller than at least the minimum width dimension of the tip portion of the finger.

### 2-10. Processing Device 30

The processing device 30 is electrically connected to the sensor sheet 20 via the first lead wire 28 and the second lead wire 29. The processing device 30 acquires a voltage or current from the sensor sheet 20, and performs a detection calculation for the object movement based on the acquired voltage or current.

### 3. Effects of This Embodiment

Next, the effects of this embodiment will be described. The detection electrode 22 is made of an elastomer including a conductive filler, and therefore has a greater electrical resistivity than a metal sheet or a conductive cloth. However, the sensor sheet 20 includes the first wiring conductor 24. This can reduce the electrical resistance of the sensor sheet 20, thereby improving the detection accuracy of the sensor sheet 20.

One end 24A of the first wiring conductor 24 is electrically connected to the first lead wire 28 and is disposed in a state of contact with the first lead wire 28. In addition, the other end 24B of the first wiring conductor 24 is spaced apart from the first bypass conductor 23 with the first end portion gap 41 therebetween. This allows the sensor sheet 20 to deform easily in the first end portion gap 41. As a result, the sensor sheet 20 as a whole is easily deformed, so the sensor sheet 20 has good attachability when attached to the steering wheel 10.

Moreover, the electrical resistance between the first lead wire 28 and the first bypass conductor 23 can be reduced compared to a case without the first wiring conductor 24. This can improve the detection accuracy of the sensor sheet 20.

Furthermore, according to this embodiment, the first bypass conductor 23 includes the plurality of first divided bypass conductors 23A arranged with the first bypass intermediate gaps 40 therebetween. This allows the sensor sheet 20 to deform easily in the first bypass intermediate gap 40. As a result, the sensor sheet 20 as a whole is easily deformed, so the sensor sheet 20 has better attachability when attached to the steering wheel 10.

According to this embodiment, each of the first bypass intermediate gaps 40 and each of the second bypass intermediate gaps 42 are disposed at positions overlapping each other in the thickness direction of the insulator sheet 21. The first end portion gap 41 and the second end portion gap 43 are disposed at positions overlapping each other in the thickness direction of the insulator sheet 21. Thus, the sensor sheet 20 is easily deformed, which improves the attachability when the sensor sheet 20 is attached to the steering wheel 10.

In this embodiment, the gap dimension of the first bypass intermediate gap 40 is set to be larger than the gap dimension of the first end portion gap 41 with respect to the longitudinal direction. Such an embodiment is effective for a case where flexibility is required in the region of the sensor sheet 20 in which the first bypass conductor 23 is disposed.

### Second Embodiment

The second embodiment will be described with reference to FIG. 8. In addition, among the reference numerals used in the second and subsequent embodiments, the same reference numerals as used in the previous embodiment represent the same components as in the previous embodiment, unless otherwise specified.

In this embodiment, the gap dimension of the first bypass intermediate gap 40 is smaller than the gap dimension of the first end portion gap 41 with respect to the longitudinal direction. Thus, this embodiment is effective for a case where flexibility is required in the region of the sensor sheet 20 in which the first wiring conductor 24 and the first lead wire 28 are disposed.

### Third Embodiment

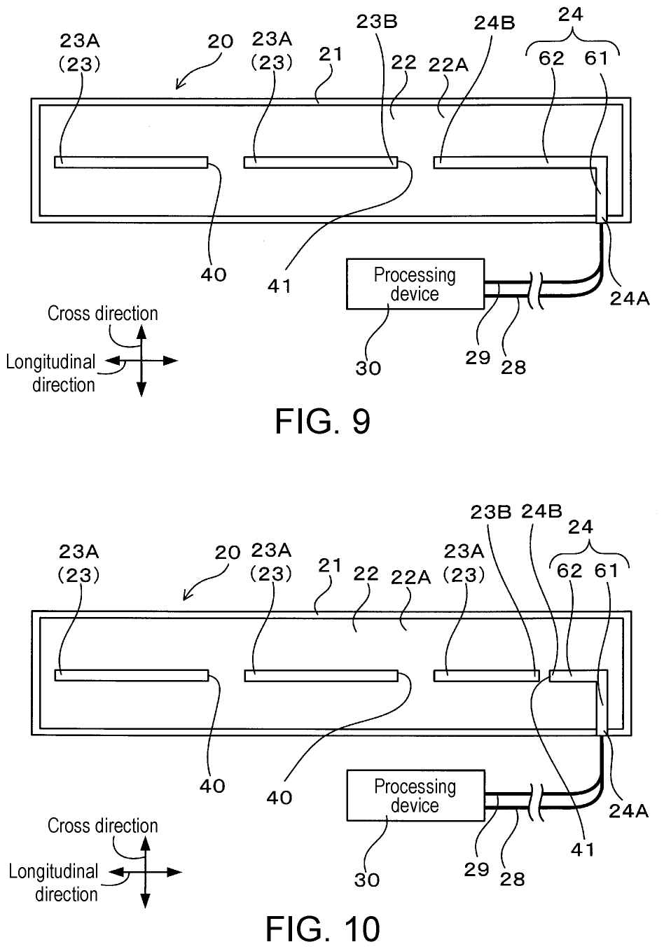

The third embodiment will be described with reference to FIG. 9. In this embodiment, the first bypass conductor 23 includes two first divided bypass conductors 23A arranged side by side in the longitudinal direction. However, the number of the first divided bypass conductors 23A is arbitrary.

The first wiring conductor 24 of this embodiment includes a first extension portion 61 electrically connected to the first lead wire 28 and extending in the cross direction, and a second extension portion 62 extending in the longitudinal direction from the end portion on the side opposite to the first lead wire 28 and bending in a direction approaching the first bypass conductor 23. The length dimension of the first extension portion 61 in the cross direction is formed smaller than the length dimension of the second extension portion 62 in the longitudinal direction. The end portion of the second extension portion 62 on the side opposite to the first extension portion 61 is defined as the other end 24B of the first wiring conductor 24. The first end portion gap 41 is formed between the other end 24B of the first wiring conductor 24 and one end 23B of the first divided bypass conductor 23A.

According to this embodiment, the first wiring conductor 24 includes the second extension portion 62 extending in a direction approaching the first bypass conductor 23, so the electrical resistance of the sensor sheet 20 can be reduced. This embodiment is effective for a configuration in which flexibility is not required in the region of the sensor sheet 20 where the first bypass conductor 23 and the first wiring conductor 24 are disposed.

### Fourth Embodiment

The fourth embodiment will be described with reference to FIG. 10. In this embodiment, the first bypass conductor 23 includes three first divided bypass conductors 23A. Among the three first divided bypass conductors 23A, the first divided bypass conductor 23A at the right end in FIG. 10 is formed to have a smaller length dimension in the longitudinal direction than the other two first divided bypass conductors 23A. However, the number of the first divided bypass conductors 23A is arbitrary.

The first wiring conductor 24 of this embodiment includes a first extension portion 61 electrically connected to the first lead wire 28 and extending in the cross direction, and a second extension portion 62 extending in the longitudinal direction from the end portion on the side opposite to the first lead wire 28 and bending in a direction approaching the first bypass conductor 23. The length dimension of the first extension portion 61 in the cross direction is formed larger than the length dimension of the second extension portion 62 in the longitudinal direction. The end portion of the second extension portion 62 on the side opposite to the first extension portion 61 is defined as the other end 24B of the first wiring conductor 24. The first end portion gap 41 is formed between the other end 24B of the first wiring conductor 24 and one end 23B of the first divided bypass conductor 23A at the right end in FIG. 10.

In this embodiment, the gap dimension of the first bypass intermediate gap 40 is set to be larger than the gap dimension of the first end portion gap 41 with respect to the longitudinal direction.

By providing the second extension portion 62, it is possible to reduce the electrical resistance of the sensor sheet 20. In addition, as the gap dimension of the first bypass intermediate gap 40 is set to be larger than the gap dimension of the first end portion gap 41 with respect to the longitudinal direction, it is possible to improve the flexibility of the sensor sheet 20 with respect to the longitudinal direction.

### Fifth Embodiment

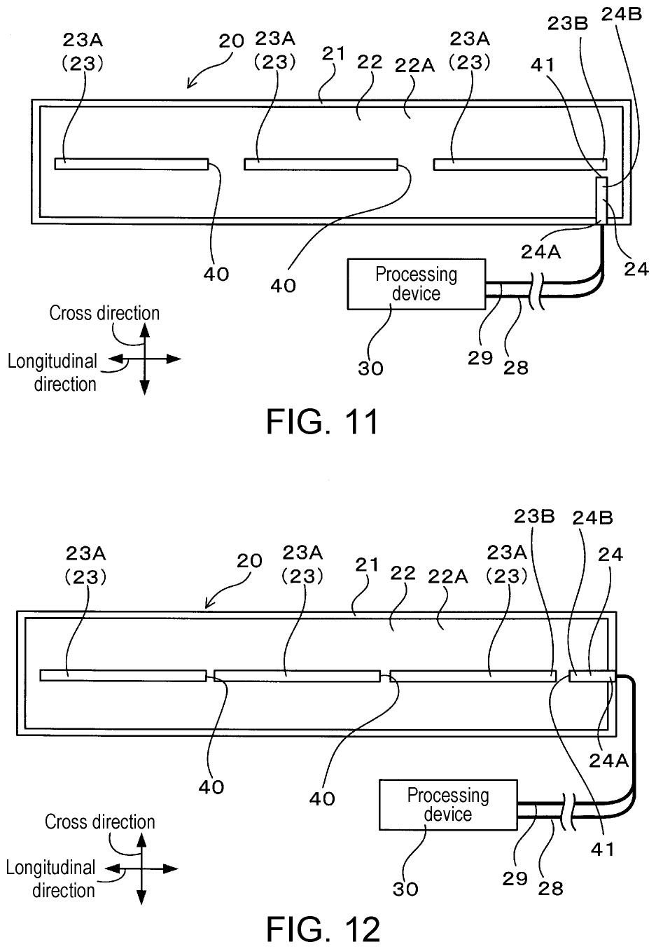

The fifth embodiment will be described with reference to FIG. 11. In this embodiment, the first wiring conductor 24 is spaced apart in the cross direction from one end of the first bypass conductor 23 in the longitudinal direction. The first wiring conductor 24 extends in the cross direction and is electrically connected to the first lead wire 28.

In this embodiment, the first end portion gap 41 is formed between one end 23B (the right end in FIG. 11) of the first divided bypass conductor 23A located at the right end in FIG. 11 among the plurality of (three in this embodiment) first divided bypass conductors 23A that constitute the first bypass conductor 23, and the other end 24B of the first wiring conductor 24.

According to this embodiment, the first bypass conductor 23 and the first wiring conductor 24 are spaced apart with respect to the cross direction, so it is effective for a case where the sensor sheet 20 is required to have flexibility with respect to the cross direction.

### Sixth Embodiment

The sixth embodiment will be described with reference to FIG. 12. In this embodiment, the first wiring conductor 24 extends in the longitudinal direction. One end 24A of the first wiring conductor 24 is disposed at one end (the right end in FIG. 12) of the insulator sheet 21 in the longitudinal direction and is electrically connected to the first lead wire 28.

This embodiment is effective for a case where it is required to lead out the first lead wire 28 from the end portion of the sensor sheet 20 in the longitudinal direction.

### Seventh Embodiment

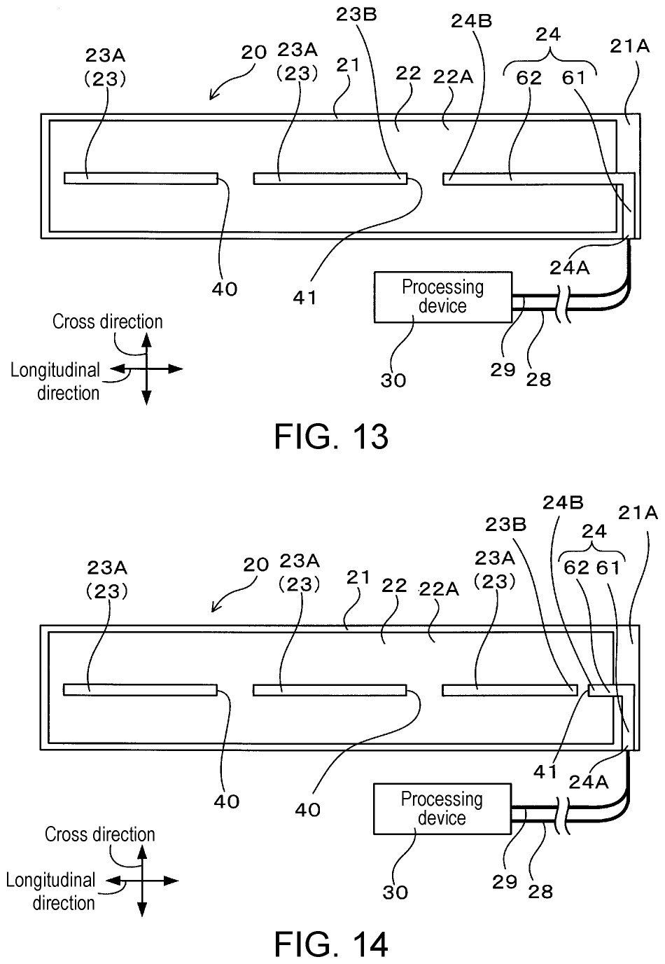

The seventh embodiment will be described with reference to FIG. 13. In this embodiment, one end (the right end in FIG. 13) of the detection electrode 22 in the longitudinal direction is located slightly inward (to the left in FIG. 13) from one end (the right end in FIG. 13) of the insulator sheet 21 with respect to the longitudinal direction. Thus, an exposed region 21A is formed where the upper surface of the insulator sheet 21 is exposed from the detection electrode 22. The second extension portion 62 of the first wiring conductor 24 is disposed across the detection region 22A and the exposed region 21A. The first extension portion 61 of the first wiring conductor 24 is disposed in the exposed region 21A.

In this embodiment, the first bypass conductor 23 includes two first divided bypass conductors 23A. In this embodiment, the first end portion gap 41 is formed between one end 23B of the first divided bypass conductor 23A located at the right end in FIG. 13 among the two first divided bypass conductors 23A, and the other end 24B of the first wiring conductor 24. In this embodiment, the gap dimension of the first bypass intermediate gap 40 and the gap dimension of the first end portion gap 41 are set to be the same with respect to the longitudinal direction.

Since the configuration other than the above is substantially the same as in the third embodiment, the same members are given the same reference numerals, and repeated description will be omitted.

### Eighth Embodiment

The eighth embodiment will be described with reference to FIG. 14. In this embodiment, one end (the right end in FIG. 14) of the detection electrode 22 in the longitudinal direction is located slightly inward (to the left in FIG. 14) from one end (the right end in FIG. 14) of the insulator sheet 21 with respect to the longitudinal direction. Thus, an exposed region 21A is formed where the upper surface of the insulator sheet 21 is exposed from the detection electrode 22. The second extension portion 62 of the first wiring conductor 24 is disposed across the detection region 22A and the exposed region 21A. The first extension portion 61 of the first wiring conductor 24 is disposed in the exposed region 21A.

In this embodiment, the first bypass conductor 23 includes three first divided bypass conductors 23A. In this embodiment, the first end portion gap 41 is formed between one end 23B of the first divided bypass conductor 23A located at the right end in FIG. 14 among the three first divided bypass conductors 23A, and the other end 24B of the first wiring conductor 24. In this embodiment, the gap dimension of the first bypass intermediate gap 40 is larger than the gap dimension of the first end portion gap 41 with respect to the longitudinal direction.

Since the configuration other than the above is substantially the same as in the fourth embodiment, the same members are given the same reference numerals, and repeated description will be omitted.

### Ninth Embodiment

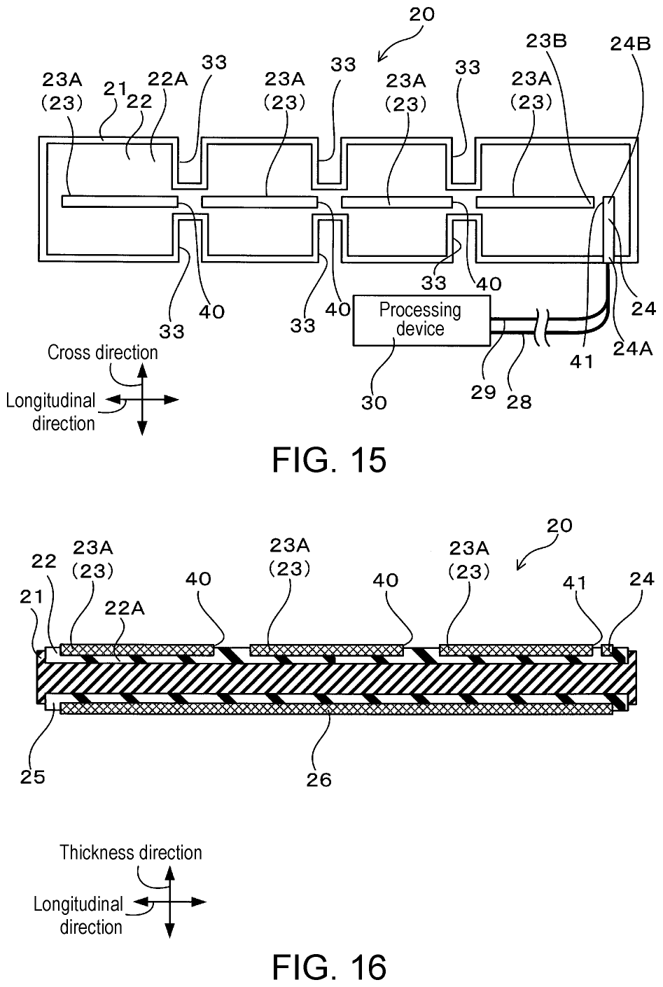

The ninth embodiment will be described with reference to FIG. 15. The sensor sheet 20 of this embodiment has cutout portions 33 that open outward with respect to the cross direction on a pair of outer edges extending in the longitudinal direction. A plurality of (three in this embodiment) cutout portions 33 are formed on each outer edge. The cutout portions 33 formed on each outer edge are formed at positions overlapping each other in the cross direction. However, the number of the cutout portions 33 formed on each outer edge is arbitrary, and may be one to two, or four or more.

The first bypass intermediate gap 40 is formed at a position corresponding to the cutout portion 33. More specifically, the cutout portion 33 and the first bypass intermediate gap 40 are formed at positions overlapping each other with respect to the cross direction.

Further, the width dimension of the cutout portion 33 in the longitudinal direction is set to be larger than the gap dimension of the first bypass intermediate gap 40.

According to this embodiment, the provision of the cutout portions 33 makes it easy to wind the sensor sheet 20 around the steering wheel 10. In particular, the portion where the cutout portion 33 is provided has a small length dimension in the cross direction of the sensor sheet 20, so the sensor sheet 20 is easily deformed. Since the first bypass intermediate gap 40 is disposed at a position corresponding to the cutout portion 33, the sensor sheet 20 is more easily deformed. Thus, the attachability of the sensor sheet 20 to the steering wheel 10 is further improved.

The positions of the cutout portions 33 formed on each outer edge are not particularly limited, and may be positions different from the overlapping positions in the cross direction.

Although this embodiment has a configuration in which the cutout portions 33 are formed on both of a pair of outer edges, the disclosure is not limited thereto, and the cutout portions 33 may be formed on one outer edge and not on the other outer edge.

### Tenth Embodiment

The tenth embodiment will be described with reference to FIG. 16. According to this embodiment, the second bypass conductor 26 is disposed to extend from one end portion to the other end portion of the insulator sheet 21 with respect to the longitudinal direction. In other words, the second bypass conductor 26 of this embodiment is not divided into the second divided bypass conductors 26A.

### Eleventh Embodiment

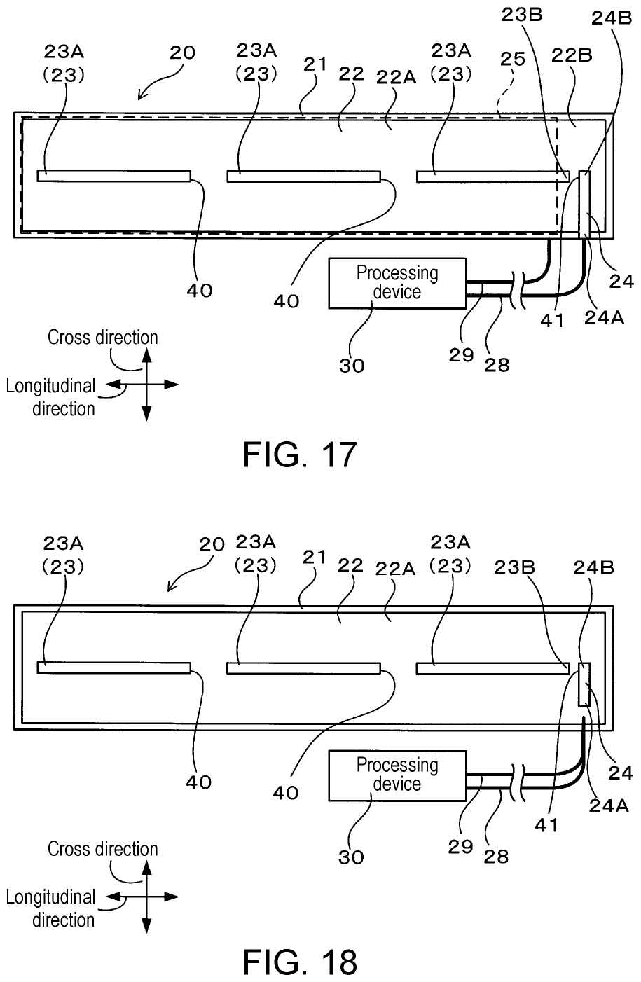

The eleventh embodiment will be described with reference to FIG. 17. In this embodiment, one end portion (the right end in FIG. 17) of the shield electrode 25 in the longitudinal direction is located inward (to the left in FIG. 17) with respect to the longitudinal direction from one end portion (the right end in FIG. 17) of the detection electrode 22 in the longitudinal direction. Thus, an electrical connection region 22B is formed in which the detection electrode 22 and the shield electrode 25 do not overlap each other with respect to the thickness direction of the insulator sheet 21. In the electrical connection region 22B, the first divided bypass conductors 23A constituting the first bypass conductor 23 and the first wiring conductor 24 are electrically connected via the detection electrode 22.

As described above, the region where the detection electrode 22 and the shield electrode 25 overlap in the thickness direction of the insulator sheet 21 is defined as the detection region 22A. The detection region 22A and the electrical connection region 22B are defined as different regions in the detection electrode 22.

The first divided bypass conductors 23A constituting the first bypass conductor 23 is disposed across the detection region 22A and the electrical connection region 22B. Furthermore, the first wiring conductor 24 is disposed in the electrical connection region 22B.

In the electrical connection region 22B, the detection electrode 22 and the shield electrode 25 do not overlap with respect to the thickness direction, so the flexibility of the sensor sheet 20 is improved. In other words, the flexibility of the region in which the first lead wire 28 and the first wiring conductor 24 are disposed is improved, and therefore the attachability of the sensor sheet 20 to the steering wheel 10 is improved.

In addition, in this embodiment, the position where the first lead wire 28 is led out from the sensor sheet 20 and the position where the second lead wire 29 is led out from the sensor sheet 20 are shifted in the longitudinal direction. This allows the thickness of the sensor sheet 20 to be reduced.

### Twelfth Embodiment

The twelfth embodiment will be described with reference to FIG. 18. In this embodiment, one end 24A of the first wiring conductor 24 is spaced apart from the first lead wire 28. On the other hand, the other end 24B of the first wiring conductor 24 is spaced apart from one end 23B of the first bypass conductor 23 with the first end portion gap 41 therebetween. One end 24A of the first wiring conductor 24 is disposed at a position closer to the first lead wire 28 than the first bypass conductor 23. The first lead wire 28, the first wiring conductor 24, and the first bypass conductor 23 are electrically connected via the detection electrode 22.

According to this embodiment, the first lead wire 28 and the first wiring conductor 24 are disposed with a gap therebetween, so the flexibility of the sensor sheet 20 with respect to the cross direction is improved. Thus, the attachability of the sensor sheet 20 to the steering wheel 10 is improved.

### Thirteenth Embodiment

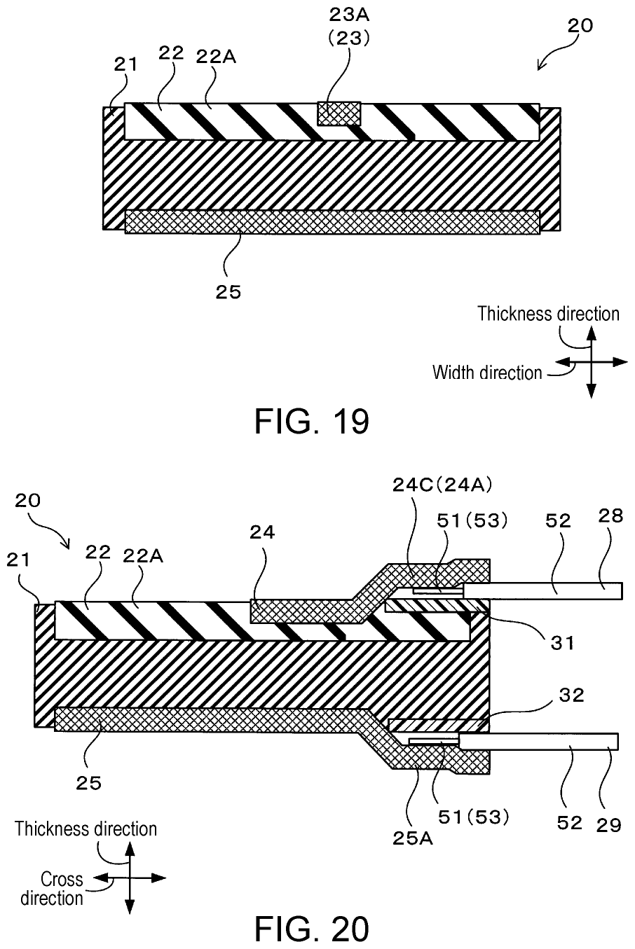

The thirteenth embodiment will be described with reference to FIG. 19 to FIG. 20. In this embodiment, the shield electrode 25 is a conductive cloth disposed on the lower surface (the lower surface in FIG. 19) of the insulator sheet 21. This embodiment differs from the first embodiment in that this embodiment does not have the second bypass conductor 26 and the second wiring conductor 27.

As shown in FIG. 19, the shield electrode 25 is disposed to overlap the detection electrode 22 with respect to the thickness direction of the insulator sheet 21.

As shown in FIG. 20, one end portion of the shield electrode 25 is defined as a non-contact region 25A that is not in contact with the lower surface of the insulator sheet 21. The second bond restriction layer 32 is disposed on the lower surface of the insulator sheet 21 at a position corresponding to the non-contact region 25A of the shield electrode 25. Since the connection structure between the second lead wire 29 and the non-contact region 25A of the shield electrode 25 is substantially the same as the connection structure between the second wiring conductor 27 and the second lead wire 29 described in the first embodiment, repeated description will be omitted.

According to this embodiment, the detection electrode 22 made of a conductive elastomer is disposed on the upper surface of the insulator sheet 21, so the flexibility of the sensor sheet 20 is improved. Thus, the attachability of the sensor sheet 20 to the steering wheel 10 is improved.

### Fourteenth Embodiment

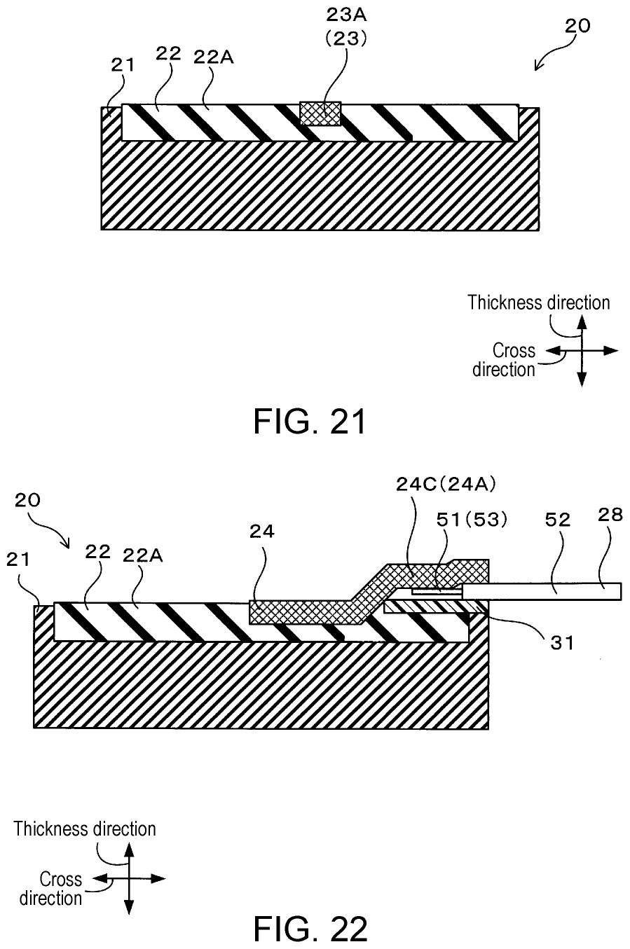

The fourteenth embodiment will be described with reference to FIG. 21 to FIG. 22. In this embodiment, the sensor sheet 20 differs from the first embodiment in that the sensor sheet 20 does not include the shield electrode 25, the second bypass conductor 26, the second wiring conductor 27, the second bond restriction layer 32, and the second lead wire 29. In this embodiment, the surface of the insulator sheet 21 opposite to the side where the detection electrode 22 is disposed is configured to be in contact with the resin inner layer material 16. In this embodiment, the core material 15 is connected to the ground potential. Thus, the shield electrode 25 is not required in this embodiment.

According to this embodiment, the sensor sheet 20 does not have the shield electrode 25, thereby improving the flexibility of the sensor sheet 20.

The sensor sheets 20 of the second to twelfth embodiments may have a configuration without the shield electrode 25, the second bypass conductor 26, the second wiring conductor 27, the second bond restriction layer 32, and the second lead wire 29.

### Fifteenth Embodiment

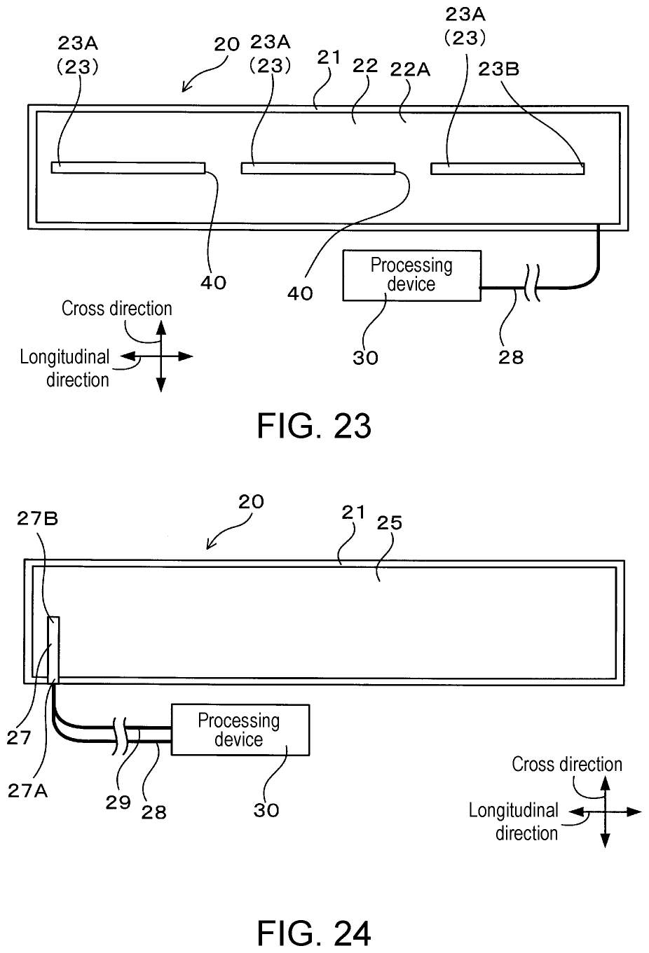

The fifteenth embodiment will be described with reference to FIG. 23. In this embodiment, the sensor sheet 20 differs from the fourteenth embodiment in that the sensor sheet 20 does not include the first wiring conductor 24. The first lead wire 28 is electrically connected to the detection electrode 22 by a known method.

According to this embodiment, the sensor sheet 20 does not have the first wiring conductor 24, thereby improving the flexibility of the sensor sheet 20.

The sensor sheets 20 of the first to twelfth embodiments may have a configuration without the first wiring conductor 24.

### Sixteenth Embodiment

The sixteenth embodiment will be described with reference to FIG. 24. This embodiment differs from the first embodiment in that the sensor sheet 20 does not include the second bypass conductor 26. According to this embodiment, the sensor sheet 20 does not have the second bypass conductor 26, thereby improving the flexibility of the sensor sheet 20.

The sensor sheets 20 of the second to twelfth embodiments may have a configuration without the second bypass conductor 26.

In this embodiment, the other end 27B of the second wiring conductor 27 is disposed near the center position of the shield electrode 25 with respect to the cross direction, but the disclosure is not limited thereto, and the other end 27B of the second wiring conductor 27 may be disposed on a side edge of the shield electrode 25 that intersects with the cross direction, or may be disposed at any position. Moreover, the second wiring conductor 27 may be omitted, and the second lead wire 29 may be electrically connected to the shield electrode 25.

The disclosure is not limited to the above-described embodiments, and can be applied to various embodiments without departing from the gist of the disclosure.

What is claimed is:

1. A sensor sheet (20) to be wound around a winding target member of a steering wheel (10) that has a core material (15), the sensor sheet comprising:
an insulator sheet (21) made of an elastomer;
at least one detection electrode (22) made of an elastomer that comprises a conductive material, disposed on an upper surface of the insulator sheet, and constituting at least one detection region (22A);
a first bypass conductor (23) disposed on an upper surface of the detection electrode and extending in a longitudinal direction corresponding to a direction of a central axis (14) of the winding target member;
a first lead wire (28) associated with the detection electrode; and
a first wiring conductor (24) disposed between the first bypass conductor and the first lead wire, spaced apart from the first bypass conductor, and electrically connected to the detection electrode,
wherein one end (24A) of the first wiring conductor is electrically connected to the first lead wire, and is disposed in a state of contact with the first lead wire or is disposed at a position closer to the first lead wire than the first bypass conductor, and
an other end (24B) of the first wiring conductor is disposed at a position closer to the first bypass conductor than one end of the first wiring conductor, and is spaced apart from the first bypass conductor with a first end portion gap (41) therebetween.

2. The sensor sheet according to claim 1, wherein the first wiring conductor is spaced apart in the longitudinal direction from one end of the first bypass conductor in the longitudinal direction, and extends in a cross direction intersecting with the longitudinal direction to be electrically connected to the first lead wire.

3. The sensor sheet according to claim 2, wherein the first wiring conductor extends linearly in the cross direction.

4. The sensor sheet according to claim 2, wherein the first wiring conductor comprises:
a first extension portion (61) electrically connected to the first lead wire and extending in the cross direction; and
a second extension portion (62) extending in the longitudinal direction from an end portion on a side opposite to the first lead wire and bending in a direction approaching the first bypass conductor.

5. The sensor sheet according to claim 1, wherein the first wiring conductor extends in the longitudinal direction from a position spaced apart in the longitudinal direction from one end of the first bypass conductor in the longitudinal direction to be electrically connected to the first lead wire.

6. The sensor sheet according to claim 1, wherein the first wiring conductor is spaced apart in a cross direction intersecting with the longitudinal direction from one end of the first bypass conductor in the longitudinal direction, and extends in the cross direction to be electrically connected to the first lead wire.

7. The sensor sheet according to claim 1, wherein the first bypass conductor comprises a plurality of first divided bypass conductors (23A) arranged in the longitudinal direction with first bypass intermediate gaps (40) therebetween.

8. The sensor sheet according to claim 7, wherein the sensor sheet has cutout portions (33) that open outward on at least one of outer edges extending in the longitudinal direction, and the first bypass intermediate gaps (40) are formed at positions corresponding to the cutout portions.

9. The sensor sheet according to claim 8, wherein a width dimension of the cutout portion in the longitudinal direction is larger than the first bypass intermediate gap.

10. The sensor sheet according to claim 8, wherein the first bypass intermediate gap is smaller than a minimum width dimension of a detection object.

11. The sensor sheet according to claim 1, wherein the first bypass conductor is made of a conductive fiber.

12. The sensor sheet according to claim 1, wherein the first bypass conductor is made of a metal wire.

13. The sensor sheet according to claim 1, wherein the first bypass conductor is made of an elastomer that comprises a conductive material, and has an electrical resistivity smaller than an electrical resistivity of the detection electrode.

14. The sensor sheet according to claim 1, wherein the first bypass conductor is disposed in the detection region, and
at least a part of the first wiring conductor is disposed in the detection region.

15. The sensor sheet according to claim 1, wherein the detection electrode comprises an electrical connection region (22B) that is a region different from the detection region and is electrically connected to the first bypass conductor and the first wiring conductor,
the first bypass conductor is disposed across the detection region and the electrical connection region, and
the first wiring conductor is disposed in the electrical connection region.

16. The sensor sheet according to claim 1, further comprising:
at least one shield electrode (25) made of an elastomer that comprises a conductive material and disposed on a lower surface of the insulator sheet;
a second bypass conductor (26) disposed on a lower surface of the shield electrode and extending in the longitudinal direction corresponding to the direction of the central axis of the winding target member;
a second lead wire (29); and
a second wiring conductor (27) disposed between the second bypass conductor and the second lead wire and spaced apart from the second bypass conductor,
wherein one end (27A) of the second wiring conductor is electrically connected to the second lead wire, and is disposed in a state of contact with the second lead wire or is disposed at a position closer to the second lead wire than the second bypass conductor, and
an other end (27B) of the second wiring conductor is spaced apart from the second bypass conductor with a second end portion gap (43) therebetween.

17. The sensor sheet according to claim 16, wherein the second bypass conductor comprises a plurality of second divided bypass conductors (26A) arranged in the longitudinal direction with second bypass intermediate gaps (42) therebetween.

18. The sensor sheet according to claim 17, wherein the first bypass conductor comprises a plurality of first divided bypass conductors (23A) arranged in the longitudinal direction with first bypass intermediate gaps (40) therebetween,
the first end portion gap and the second end portion gap are disposed at positions overlapping each other in a thickness direction of the insulator sheet, and
the first bypass intermediate gaps and the second bypass intermediate gaps are disposed at positions overlapping each other in the thickness direction of the insulator sheet.

19. A sensor sheet to be wound around a winding target member of a steering wheel that has a core material, the sensor sheet comprising:
an insulator sheet made of an elastomer;
at least one detection electrode made of an elastomer that comprises a conductive material, disposed on an upper surface of the insulator sheet, and constituting at least one detection region; and
a first bypass conductor disposed on an upper surface of each of the at least one detection electrode and extending in a longitudinal direction corresponding to a direction of a central axis of the winding target member,
wherein the first bypass conductor comprises a plurality of first divided bypass conductors arranged in the longitudinal direction with first bypass intermediate gaps therebetween.

20. The sensor sheet according to claim 19, further comprising:
a first lead wire associated with the detection electrode; and
a first wiring conductor disposed between the first bypass conductor and the first lead wire,
wherein the first wiring conductor is connected to one of the plurality of first divided bypass conductors.

21. The sensor sheet according to claim 19, wherein the sensor sheet has cutout portions that open outward on at least one of outer edges in the longitudinal direction, and the first bypass intermediate gaps are formed at positions corresponding to the cutout portions.

22. The sensor sheet according to claim 21, wherein a width dimension of the cutout portion is larger than the first bypass intermediate gap with respect to the longitudinal direction.

23. The sensor sheet according to claim 19, wherein the first bypass intermediate gap is smaller than a minimum width dimension of a detection object.
